(19) United States
(12) Patent Application Publication
(10) Pub. No.: US 2024/0420589 A1
(43) Pub. Date: Dec. 19, 2024

(54) FRETLESS ONE-STRINGED TRAINING INSTRUMENT

(71) Applicant: Buffalo Games, LLC, Buffalo, NY (US)

(72) Inventor: Brian Calhoun, Charlottesville, VA (US)

(21) Appl. No.: 18/678,416

(22) Filed: May 30, 2024

Related U.S. Application Data
(60) Provisional application No. 63/507,881, filed on Jun. 13, 2023.

(51) Int. Cl. G09B 15/02; G10D 1/08; G10D 3/04; G10D 3/06; G10D 3/12; G10D 3/14; G10G 1/02; G10G 5/00

(52) U.S. Cl. CPC G09B 15/026; G10D 1/08; G10D 3/04; G10D 3/06; G10D 3/12; G10D 3/14; G10G 1/02; G10G 5/005

(57) ABSTRACT

A fretless, one-stringed instrument includes a neck having a head formed at one end; a body joined to the neck; and a single instrument string joined to the body and tightenably fastened at the head. No additional strings are present on the instrument and no fret is present on the neck. The neck includes a flat fingerboard having color-coded and numbered finger indicia and divider markings. The body has a front surface and a rear surface between which a cavity is formed. The cavity connects to a hole formed through the front surface. A method of instructing a student to play guitar with the instrument includes the student grasping the instrument; placing fingers on a selected sequence of the finger indicia as indicated in a guide; and strumming the string with a digit of the other hand.

### CROSS-REFERENCE TO RELATED APPLICATION

This application claims the benefit of priority of U.S. provisional application No. 63/507,881, filed Jun. 13, 2023, the contents of which are herein incorporated by reference.

### BACKGROUND OF THE INVENTION

The present invention relates to musical instruments and, more particularly, to a fretless one-stringed training instrument.

While violinists often start learning to play as early as age 3. Guitarists generally do not start playing that young. While a violin is a melody instrument, guitars are typically chord-based. Small children can strum guitar strings but do not have the coordination to hold a chord or fret and pluck individual notes.

As can be seen, there is a need for a training instrument that introduces guitar playing to young children.

### SUMMARY OF THE INVENTION

In one aspect of the present invention, a fretless, one-stringed instrument (10) comprises a neck (20) having a first end and a second end, with a head (12) formed at the first end, the neck (20) including a flat fingerboard (22) having color-coded and/or numbered finger indicia (24) and divider markings (26) arrayed thereon; a body (30) joined to the second end, the body (30) having a front surface and a rear surface (40) with a cavity formed therebetween, the cavity communicating with an aperture (38) formed through the front surface; and a single instrument string (28) joined to the body (30) and tightenably fastened at the head (12); wherein no additional strings are present on the instrument and wherein no fret is present on the neck.

In another aspect of the present invention, a method of instructing a student to play guitar comprises providing the fretless one-stringed instrument and a guide correlating the color-coded and/or numbered finger indicia to musical notes; the student grasping the fretless one-stringed instrument in a predetermined position; placing at least one finger on a first hand of the student on a selected sequence of the finger markings as indicated in the guide; and strumming the string with a digit of a second hand of the student.

These and other features, aspects and advantages of the present invention will become better understood with reference to the following drawings, description, and claims.

### BRIEF DESCRIPTION OF THE DRAWINGS

FIG. 1 is a top plan view of a fretless, one-stringed instrument according to an embodiment of the present invention

FIG. 2 is a bottom plan view thereof;

FIG. 3 is a left side elevation view thereof;

FIG. 4 is a front elevation view thereof;

FIG. 5 is a rear perspective view thereof;

FIG. 6 is a top perspective view thereof; and

FIG. 7 is a top plan view of a fretless, one-stringed instrument according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a fretless one-stringed training instrument configured as a teaching tool for small children. The training instrument of the present subject matter generally comprises a body with a neck having a fingerboard and a head.

The training instrument is sometimes referred to as a “Tinkertar”.

The body generally has a front surface and a rear surface with a cavity formed therebetween communicating with a sound hole formed through the front surface. A bridge is joined to the front surface. The shape of the body is not particularly limited.

The fingerboard may have an array of numbered and colored finger position markings. However, the finger position markings are not particularly limited.

A tuner and a nut may be embedded in the head.

A string positioned longitudinally along the fingerboard is fixed at a first end in the body and tightenably fastened to the tuner at a second end. The string rests on the bridge adjacent to the fixed end.

The Tinkertar does NOT have frets. Instead, the neck has color coded and numbered finger position markers that correlate to teaching materials on how to play songs.

The string may be tightened or loosened to tune it to any pitch. The finger position markers do not correspond to a certain “key” or “scale” because the actual pitches of the notes (e.g., A, B, B flat, C, D etc.) are dependent on the string tightness.

The training instrument may be paired with a teaching book that shows how to play a song with simple numbers and colors corresponding to the finger position markers. This is not possible with a multiple stringed instrument.

In some embodiments, the training instrument further comprises a strap. The body may have strap attachment hardware joined thereto, such as at an end of the body opposite the neck and on a bottom surface of the body adjacent to an edge.

A method of instructing a student to play guitar comprises providing a fretless one-stringed instrument, with color-coded and colored finger markings, and a guide correlating the color-coded and colored finger markings to musical notes; grasping by the student the fretless one-stringed instrument in a predetermined position; placing at least one finger on a first hand of the student on a selected sequence of the finger markings as indicated in the guide; and strumming the string with a digit of a second hand of the student.

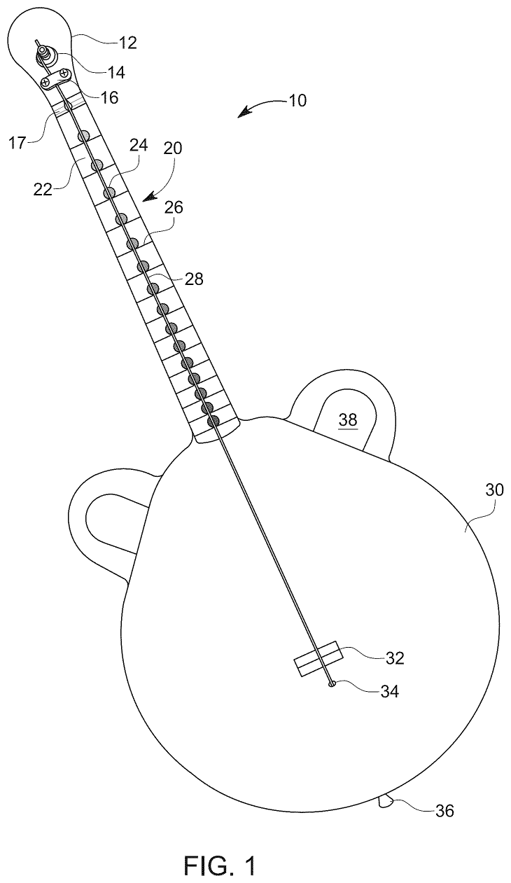

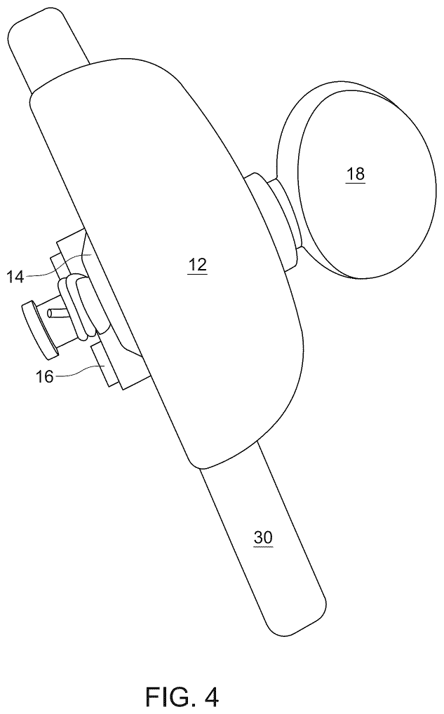

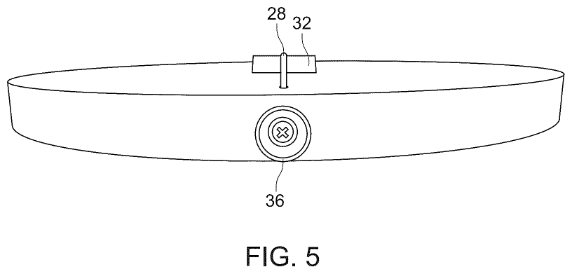

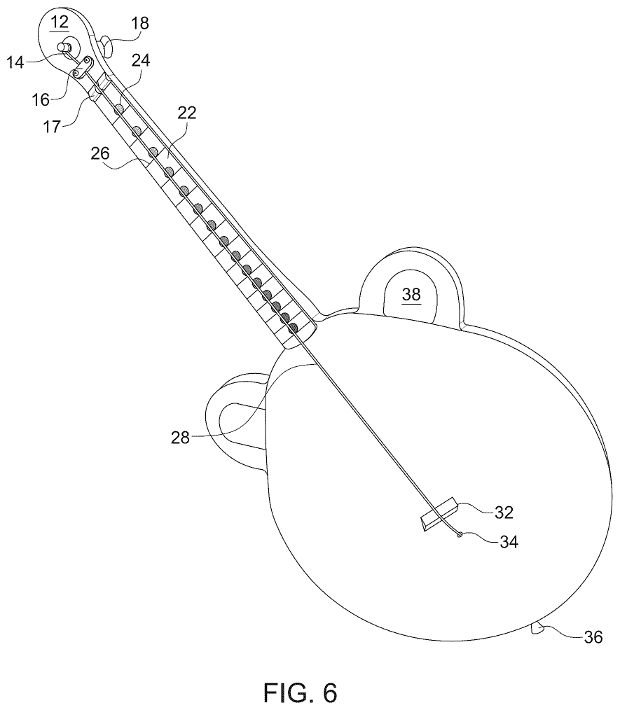

Referring to FIGS. 1 through 7, an instrument 10 according to an embodiment of the present invention comprising a head 12, a neck 20, and a body 30 is shown in FIG. 1. The head has a tuning key 14, a string guide 16, and a nut 17 fastened to a top surface thereof. The neck 20 has a flat fingerboard 22 with finger position markings 24, divider markings 26, and a string 28 which is fixedly fastened to the body 30 at point 34 and wound through the tuning key 14 at the other end. The body 30 has a first strap pin 36, a sound hole 38 and a bridge 32.

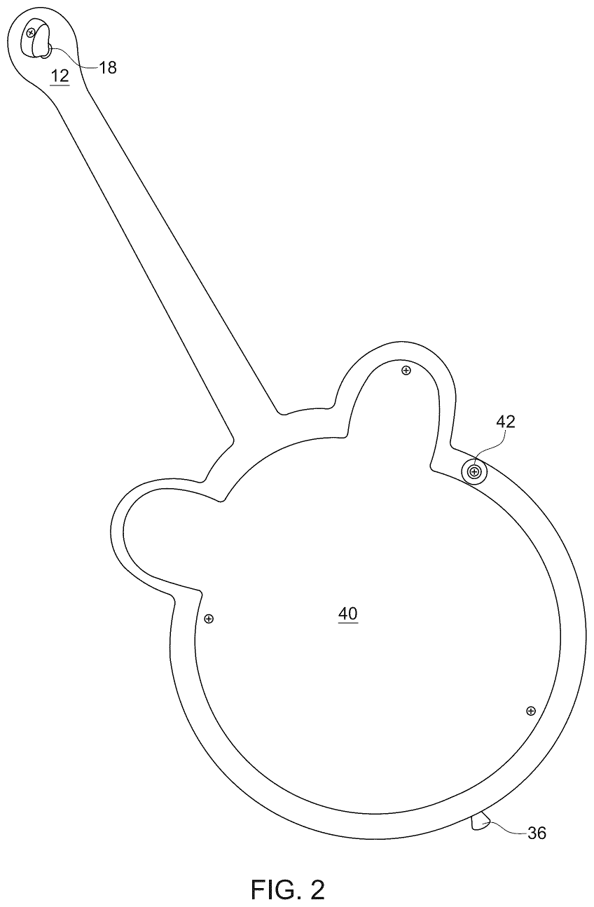

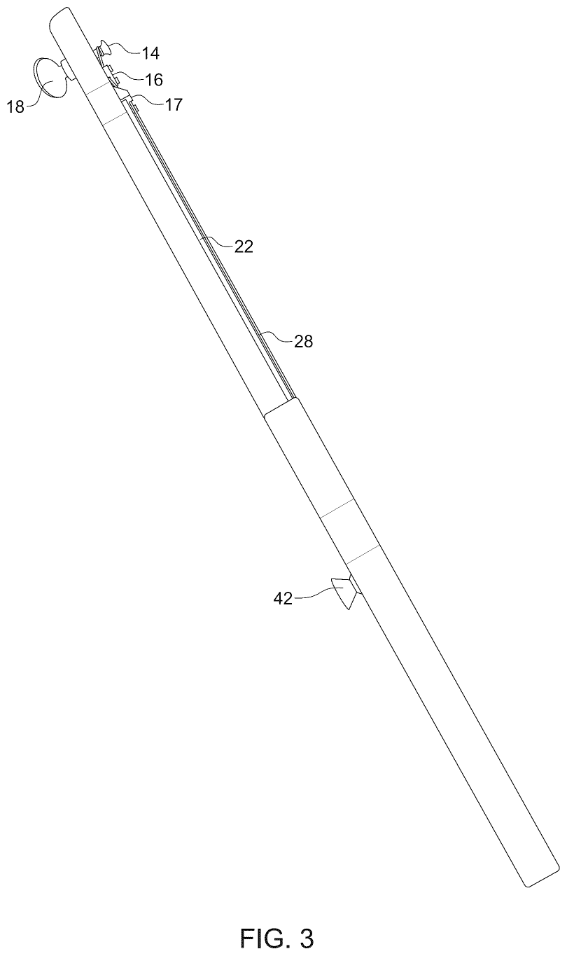

As shown in FIG. 2, the neck 12 has a tuning key knob 18 opposite the tuning key 14. The body 30 has a bottom panel 40 fastened thereto and further comprises a second strap pin 42. FIGS. 3 through 6 further illustrate the instrument 10 from various views.

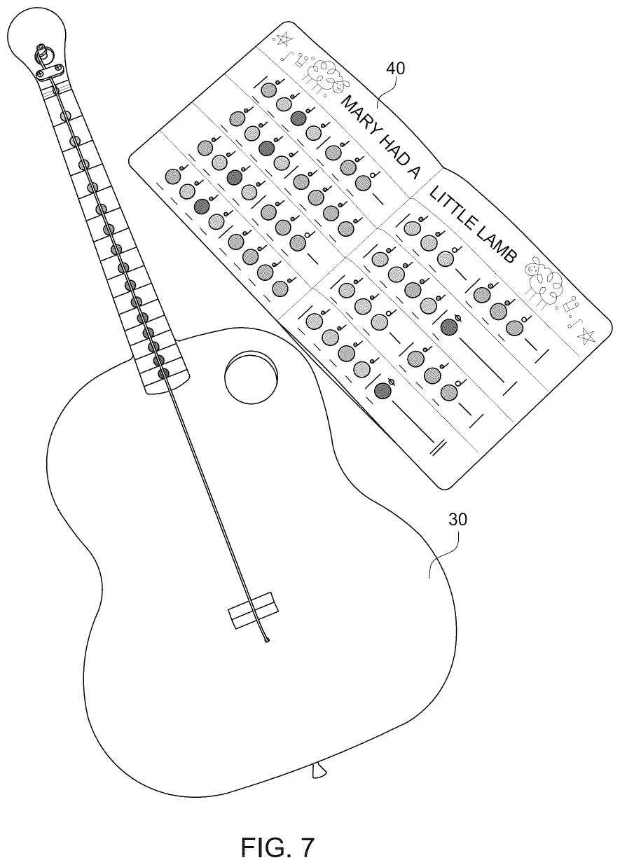

FIG. 7 shows an instrument 10 according to another embodiment of the present invention, with a different shaped body 30 and a music book 40 having instructions corresponding to the finger position markings 24 on the neck 20.

It should be understood, of course, that the foregoing relates to exemplary embodiments of the invention and that modifications may be made without departing from the spirit and scope of the invention as set forth in the following claims.

What is claimed is:

1. A fretless, one-stringed instrument (10), comprising:
a neck (20) having a first end and a second end, with a head (12) formed at the first end, the neck (20) including a flat fingerboard (22) having color-coded and/or numbered finger indicia (24) and divider markings (26) arrayed thereon;
a body (30) joined to the second end, the body (30) having a front surface and a rear surface (40) with a cavity formed therebetween, the cavity communicating with an aperture (38) formed through the front surface; and
a single instrument string (28) joined to the body (30) and tightenably fastened at the head (12);
wherein no additional strings are present on the instrument and wherein no fret is present on the neck.

2. The fretless, one-stringed instrument (10) of claim 1, further comprising a tuning key (14) extending through the head (12) to which the single instrument string (28) is fastened, the tuning key (14) having a knob (18) formed thereon, wherein the tuning key (14) is fastened to the head (12) with a nut (17).

3. The fretless, one-stringed instrument (10) of claim 1, further comprising a strap, wherein the body further comprises strap attachment hardware.

4. The fretless, one-stringed instrument (10) of claim 1, wherein the head (12) further comprises a string guide (16) and the front surface further comprises a bridge (32), and wherein the single instrument string (28) abuts the string guide (16) and the bridge (32).

5. The fretless, one-stringed instrument (10) of claim 1, wherein the rear surface (40) is removably fastened to the front surface.

6. The fretless, one-stringed instrument (10) of claim 1, wherein the divider markings (26) are level with the flat fingerboard (22).

7. A method of instructing a student to play guitar, comprising:
providing the fretless one-stringed instrument (10) of claim 1 and a guide (40) correlating the color-coded and/or numbered finger indicia (24) to musical notes;
grasping by the student the fretless one-stringed instrument (10) in a predetermined position;
placing fingers of a first hand of the student on a selected sequence of the finger indicia (24) as indicated in the guide (40); and
strumming the single instrument string (28) with a digit of a second hand of the student.
